(19) United States
(12) Patent Application Publication
(10) Pub. No.: US 2016/0268052 A1
(43) Pub. Date: Sep. 15, 2016

(54) VARIABLE CAPACITANCE BANK DEVICE

(71) Applicant: KABUSHIKI KAISHA TOSHIBA, Tokyo (JP)

(72) Inventors: Ryunosuke GANDO, Yokohama Kanagawa (JP); Daiki ONO, Yokohama Kanagawa (JP); Hiroaki YAMAZAKI, Yokohama Kanagawa (JP); Yoshihiko KURUI, Yokohama Kanagawa (JP); Tamio IKEHASHI, Yokohama Kanagawa (JP)

(73) Assignee: KABUSHIKI KAISHA TOSHIBA, Tokyo (JP)

(21) Appl. No.: 14/824,625

(22) Filed: Aug. 12, 2015

(30) Foreign Application Priority Data
Mar. 13, 2015 (JP) 2015-050620

(51) Int. Cl. H01G 5/38; H01G 5/16; H01G 5/011

(52) U.S. Cl. CPC H01G 5/38; H01G 5/011; H01G 5/16

(57) ABSTRACT

According to one embodiment, a variable capacitance bank device, including a plurality of capacitor banks for generation of a variable capacitance, the plurality of capacitor banks being connected parallel with each other. each of the capacitor banks being constituted by serially connecting a fixed capacitor for generation of a fixed capacitance and a MEMS capacitor for generation of the variable capacitance. capacitances of the fixed capacitors in different capacitor banks being set at different values. capacitances of the MEMS capacitors in different capacitor banks being set at an equal value.

### CROSS-REFERENCE TO RELATED APPLICATIONS

This application is based upon and claims the benefit of priority from Japanese Patent Application No. 2015-050620, filed Mar. 13, 2015, the entire contents of which are incorporated herein by reference.

### FIELD

Embodiments described herein relate generally to a variable capacitor bank device.

### BACKGROUND

Recently, a structure of a variable capacitance element in a micro-electro-mechanical system (MEMS) in which a MEMS element and a metal insulator metal (MIM) element are connected in series to improve the RF power resistance has been proposed. Then, a variable capacitance bank device in which a capacitor bank is formed by a serial connection of two MEMS elements and two MIM elements and a plurality of capacitor banks are connected in parallel has been proposed.

In this type of device, a 2-bit variable capacitance can be implemented by making areas of the MEMS portions different in the capacitor banks. However, the device is significantly affected by different areas of the MEMS portions and the variation in manufacture of the capacitor banks. In particular, if the variable capacitance is increased, the influence of the variation in manufacture is further increased and the reliability is significantly reduced.

### BRIEF DESCRIPTION OF THE DRAWINGS

FIG. 1A is an illustration showing a schematic configuration of a variable capacitance bank device of a first embodiment.

FIG. 1B is a circuit configuration diagram showing a schematic configuration of the variable capacitance bank device of the first embodiment.

FIG. 2A is an illustration showing a schematic configuration of a comparative example.

FIG. 2B is a circuit configuration illustration showing the schematic configuration of a comparative example.

FIG. 3 is a graph showing a capacitive characteristic of the variable capacitance bank device of the first embodiment.

FIG. 4 is a plan view showing a schematic configuration of a capacitor bank used in the first embodiment.

FIG. 5A is a cross-sectional view seen along an arrow direction of a line A-A′ in FIG. 4.

FIG. 5B is a cross-sectional view seen along an arrow direction of a line B-B′ line in FIG. 4.

FIG. 6A is an illustration showing a configuration example of a driver for driving the capacitor bank shown in FIG. 4.

FIG. 6B is a circuit diagram showing an example of a low-pass filter used for the driver shown in FIG. 6A.

FIG. 7 is a diagram showing an operation of the capacitor bank shown in FIG. 4.

FIG. 8A to FIG. 8C are cross-sectional views showing manufacturing steps of the capacitor bank shown in FIG. 4.

FIG. 9 is a plan view showing a schematic configuration of a variable capacitance bank device of a second embodiment.

FIG. 10 is a plan view showing a basic configuration of a variable capacitance bank device of a third embodiment.

FIG. 11A is a cross-sectional view seen along an arrow direction of a line C-C′ in FIG. 10.

FIG. 11B is a cross-sectional view seen along an arrow direction of a line D-D′ line in FIG. 10.

FIG. 12 is a plan view showing a schematic configuration of the variable capacitance bank device of the third embodiment.

### DETAILED DESCRIPTION

In general, according to one embodiment, a variable capacitance bank device, comprising:

a plurality of capacitor banks for generation of a variable capacitance, the plurality of capacitor banks being connected parallel,

each of the capacitor banks comprising:

a first lower electrode and a second lower electrode disposed on a substrate;

a first driving electrode having a fixed first capacitance generated between the first driving electrode and the first lower electrode;

a second driving electrode having a fixed second capacitance generated between the second driving electrode and the second lower electrode; and

a common upper electrode disposed to be movable in a direction of facing the first and second lower electrodes, having a variable third capacitance generated between the common upper electrode and the first driving electrode, and having a variable fourth capacitance generated between the common upper electrode and the second driving electrode,

a capacitance value between the first lower electrode and the second lower electrode being determined based on a value of a synthetic capacitance obtained by serially connecting the first, second, third and fourth capacitances, the value of the synthetic capacitance being used as the variable capacitance,

the first and second capacitances being set at an equal capacitance value C_{M} in a same capacitor bank, and set at different capacitance values in different capacitor banks,

the third and fourth capacitances being set at a same capacitance value C_{S} in the same capacitor bank, and set at the same capacitance value C_{S} in the different capacitor banks.

A variable capacitance bank device of the embodiments will be explained hereinafter with reference to the accompanying drawings.

### First Embodiment

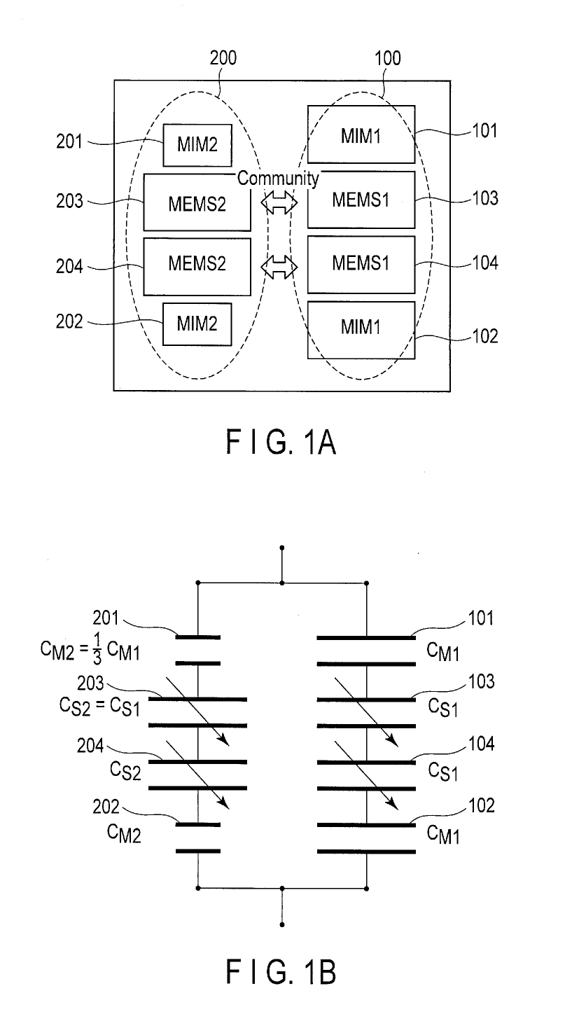

FIG. 1A and FIG. 1B are illustrations for explanation of a variable capacitance bank device of a first embodiment. FIG. 1A is a planar illustration and FIG. 1B is a circuit configuration illustration.

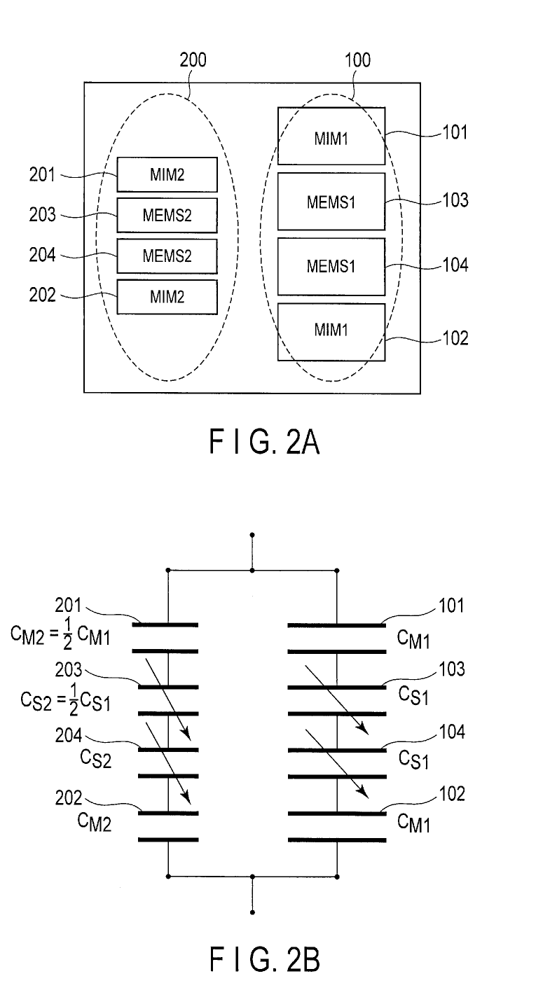

FIG. 2A and FIG. 2B are illustrations for explanation of a variable capacitance bank device of a comparative example. FIG. 2A is a planar illustration and FIG. 2B is a circuit configuration illustration.

A capacitor bank is formed by serially connecting two MEMS elements of the same configuration (same capacitance) and two MIM elements of the same configuration (same capacitance). The variable capacitance bank device is constituted by connecting two capacitor banks in parallel.

In other words, a first capacitor bank 100 is formed by serially connecting two MIM elements 101 and 102 (MIM1) and two MEMS elements 103 and 104 (MEMS1). Furthermore, a second capacitor bank 200 is formed by serially connecting two MIM elements 201 and 202 (MIM2) and two MEMS elements 203 and 204 (MEMS2). Then, a 2-bit variable capacitance bank device is constituted by connecting the first capacitor bank 100 and the second capacitor bank 200 in parallel.

In the configuration of the comparative example shown in FIG. 2A and FIG. 2B, the capacitance (area) of MIM2 is a half of the capacitance of MIM1 while the capacitance (area) of MEMS2 is a half of the capacitance of MEMS1. In other words, when the capacitance (maximum capacitance at power-on) of MEMS1 is C_{S1}, the capacitance (maximum capacitance at power-on) of MEMS2 is C_{S2}, the capacitance of MIM1 is C_{M1}, and the capacitance of MIM2 is C_{M2}, their relationship can be expressed by equations below.

C_{S2}=(½)C_{S1}, C_{M2}=(½)C_{M1}.

The capacitance of the MEMS element is maximum when a movable electrode is located most closely to a fixed electrode (power-on: down-state) or minimum when a movable electrode is located most remotely from a fixed electrode (power-off: up-state). The capacitance at power-off is extremely small relative to the capacitance at power-on and can be considered substantially zero.

The total output C_{ALL} of the variable capacitance bank device composed of a plurality of capacitor banks connected in parallel can be expressed by

C_{ALL}=ΣCk (1)

where Ck is the capacitance value of the k-th capacitor bank, which can be expressed by

Ck=C_{Sk}×C_{Mk}/{2(C_{Sk}C_{Mk})} (2)

To simplify the calculation, a capacitance C_{S1} obtained at power-on of MEMS1 and a capacitance C_{M1} of MIM1, in the configuration shown in FIG. 2, are equal to each other, which are denoted by C.

In the equation (2), a capacitance C1 of a first capacitor bank 100 at power-on of MEMS1 is

C1=C×C/{2(C+C)}=C/4

Furthermore, a capacitance C2 of a second capacitor bank 200 at power-on of MEMS2 is

C2=(½)C×(½)C/{2((½)C+(½)C)}=C/8

In other words, the capacitances are the same as those in the comparative example.

At power-off of both MEMS 1 and MEMS2 (state 1),

C_{ALL}=0,

at power-on of MEMS2 and power-off of MEMS1 (state 2),

C_{ALL}=C2=(⅛)C,

at power-on of MEMS1 and power-off of MEMS2 (state 3),

C_{ALL}=C1=( 2/8)C,

and at power-on of both MEMS 1 and MEMS2 (state 4),

C_{ALL}=C1+C2=(⅜)C.

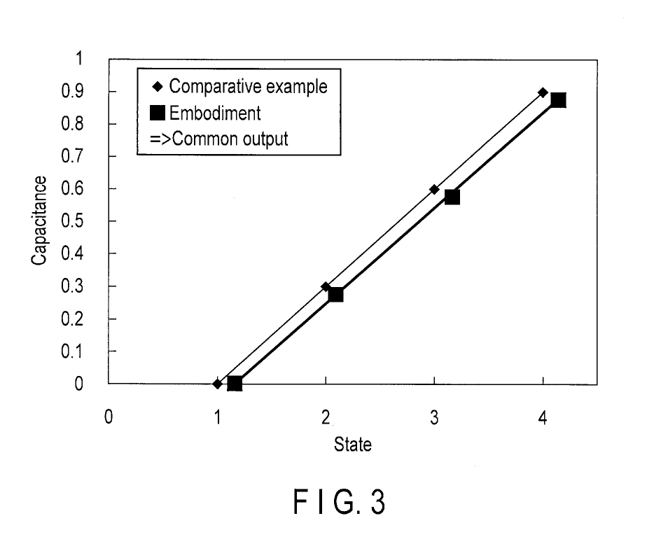

Four capacitance values 0, (⅛)C, ( 2/8)C and (⅜)C can be thus obtained by powering on and off MEMS1 and MEMS2. In other words, the 2-bit variable capacitance bank can be constituted as shown in FIG. 3. It should be noted that (⅛)C is standardized to 0.3 in FIG. 3.

In contrast, in the configuration of the present embodiment, the capacitance (area) C_{M2} of MIM2 is a third of the capacitance CM1 of MIM1, and the capacitance (area) C_{S2} of MEMS2 is equal to the capacitance C_{S1}, as shown in FIG. 1A and FIG. 1B. In other words, the capacitance C_{S2} at power-on of MEMS2 is equal to the capacitance C_{S2} at power-on of MEMS1.

In this case, if C_{S1} and C_{M1} are equal to each other and denoted by C, the capacitance C1 of the first capacitor bank 100 is, similarly to the comparative example,

C1=C×C/{2(C+C)}=C/4.

In contrast, the capacitance C2 of the second capacitor bank 200 at power-on of MEMS2 is,

C2=(⅓)C×C/{2((⅓)C+C)}=C/8

Four values 0, (⅛)C, ( 2/8)C and (⅜)C can be therefore obtained by powering on and off MEMS1 and MEMS2, similarly to the comparative example. For this reason, the 2-bit variable capacitance bank can be constituted, similarly to the example shown in FIG. 3.

According to the present embodiment, as explained above, the 2-bit variable capacitance bank can be implemented by designing the structures (areas) of MEMS capacitor modules of the first capacitor bank 100 and the second capacitor bank 200 commonly to each other and setting the MIM area of the second capacitor bank 200 to be a third of the MIM area of the first capacitor bank 100. In this case, variation in capacitance at the manufacturing can be suppressed due to the common MEMS structure. In other words, a highly reliable variable capacitance bank device having a high power resistance can be implemented by a plurality of parallel-connected capacitor banks using the MEMS elements.

In addition, if the MEMS area is smaller, the capacitance reduction rate caused by the increase in operation count becomes relatively great and the reliability decreases. Furthermore, if the MEMS area becomes smaller, a higher drive voltage is required. In contrast, in the present embodiment, use of small-area MEMS elements of lower reliability can be avoided by varying the MIM area alone without varying the MEMS area in the first capacitor bank 100 and the second capacitor bank 200. Moreover, use of small-area MEMS elements of high drive voltage can also be avoided.

The basic configuration, operation and manufacturing method of a capacitor bank will be explained here.

(Basic Configuration)

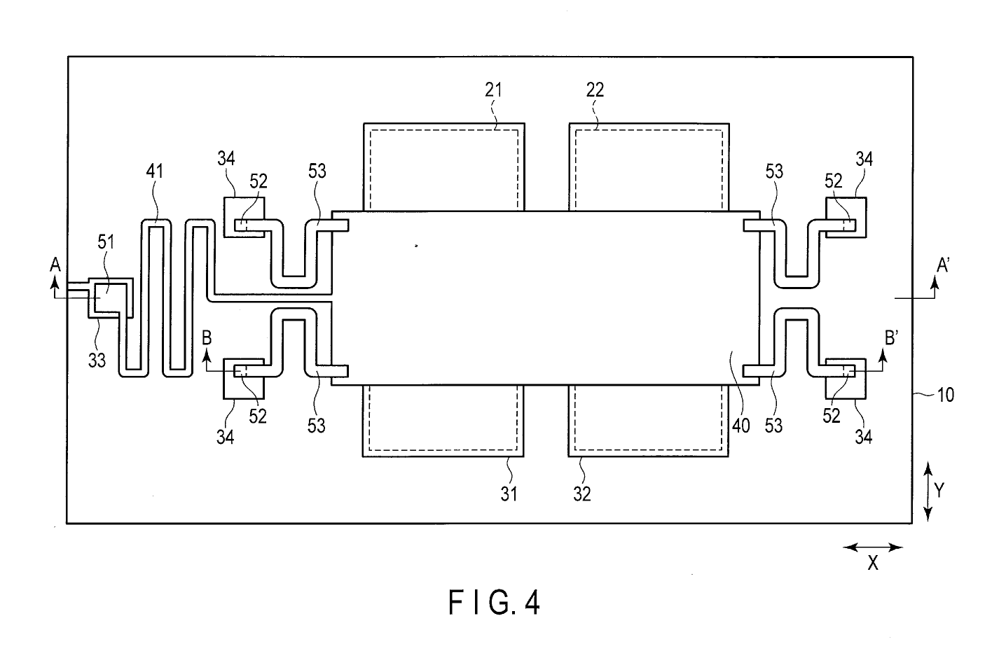

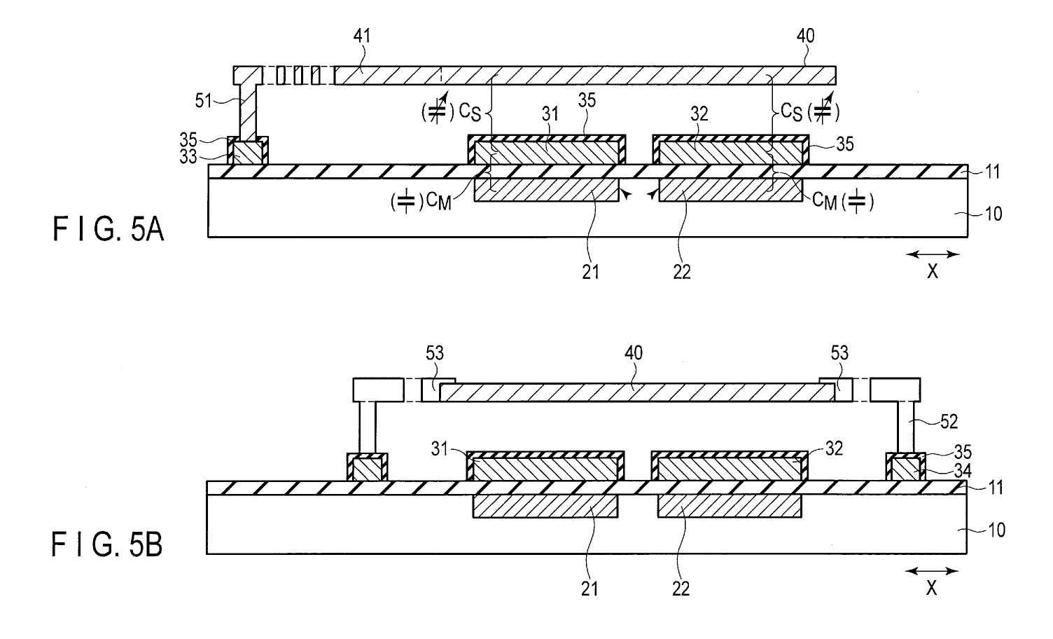

FIG. 4 is a plan view showing an example of a capacitor bank composed of two MEMS elements and two MIM elements. FIG. 5A is a cross-sectional view seen along an arrow direction of a line A-A′ in FIG. 4, and FIG. 5B is a cross-sectional view seen along an arrow direction of a line B-B′ in FIG. 4.

A first lower electrode 21 and a second lower electrode 22 are buried on a surface portion of the substrate 10. The lower electrodes 21 and 22 are formed in a rectangular shape which is longer in the X direction than in the Y direction, and are disposed side by side along the X direction so as to be parallel to each other.

The substrate 10 is, for example, an insulating substrate or a silicon substrate of glass, etc. If a silicon substrate is used as the substrate 10, elements such as field-effect transistors may be disposed on a surface region (semiconductor region) of the silicon substrate. The elements constitute a logic circuit and a storage circuit.

The lower electrodes 21 and 22 are paired, and the lower electrode 21 functions as a signal electrode while the lower electrode 22 functions as a ground electrode. A potential difference between two lower electrodes 21 and 22 is handled as a capacitor bank output (RF power/RF voltage). The potential of the lower electrode 21 is variable while the potential of the lower electrode 22 is set at a fixed potential (for example, a ground potential). The lower electrodes 21 and 22 are formed of, for example, a metal such as aluminum (Al), copper (Cu) and gold (Au) or an alloy containing any one of them.

An insulating film 11 such as a silicon oxide film is formed on the substrate 10 and the lower electrodes 21 and 22. The insulating film 11 is formed of tetraethyl orthosilicate (TEOS), etc., to decrease the parasitic capacitance.

A first driving electrode 31 is formed on the first lower electrode 21 through the insulating film 11. A second driving electrode 32 is formed on the second lower electrode 22 through the insulating film 11. The first driving electrode 31 and the second driving electrode 32 are formed of a metal such as aluminum (Al), aluminum alloy, and copper (Cu). The first driving electrode 31 and the second driving electrode 32 are formed in the same size as or slightly greater than the first lower electrode 21 and the second lower electrode 22. Surfaces of the first driving electrode 31 and the second driving electrode 32 are covered with a protective insulating film 35.

The MIM element is composed of the first lower electrode 21, the second lower electrode 22, the first driving electrode 31 and the second driving electrode 32.

A common upper electrode 40 is formed above the first driving electrode 31 and the second driving electrode 32 so as to be opposed to the first driving electrode 31 and the second driving electrode 32. The upper electrode 40 is formed of, for example, a metal such as aluminum (Al), an aluminum alloy, copper (Cu), gold (Au) and platinum (Pt). The upper electrode 40 is formed in a rectangular shape which is longer in the X direction than in the Y direction, and is disposed so as to straddle the first driving electrode 31 and the second driving electrode 32.

The MEMS element is composed of the first driving electrode 31, the second driving electrode 32 and the upper electrode 40. The upper electrode 40 may comprise an opening portion (through-hole) which penetrates from the upper surface to the bottom surface of the upper electrode 40.

An anchor portion 51 is formed on the insulating film 11. A lower end portion of the anchor portion 51 is fixed on an interconnect 33 formed on the insulating film 11. The upper electrode 40 is connected in part to an upper end portion of the anchor portion 51 via a conductive spring portion 41. The upper electrode 40 is thereby electrically connected to the interconnect 33.

The spring portion 41 is formed integrally with, for example, the upper electrode 40, such that the upper electrode 40 and the spring portion 41 are coupled as one body in a single-layer structure. The spring portion 41 is formed in, for example, a planar meander.

Four anchor portions 52 are formed on the insulating film 11 so as to correspond to four corners of the upper electrode 40. Lower end portions of the anchor portions 52 are fixed on a dummy interconnect 33 formed on the insulating film 11 through the protective insulating film 35. Four corners of the upper electrode 40 are connected to upper end portions of the anchor portions 52, respectively, via spring portions 53. The upper electrode 40 can be thereby moved in a vertical direction.

The spring portions 53 may be formed of an insulating material such as silicon oxide and silicon nitride or a semiconductor material such as polysilicon (poly-Si), silicon (Si) and silicon germanium (Site). Furthermore, the spring portions 53 may also be formed of a conductive material such as tungsten (W), molybdenum (Mo) and an aluminum-titanium (AlTi) alloy.

A spring constant of the spring portions 53 is set to be greater than a spring constant of the spring portion 41. For this reason, an interval between capacitive electrodes in a state (called an up-state) in which the upper electrode 40 is pulled upwardly is substantially determined based on the spring constant of the spring portions 53.

In the capacitor bank shown in FIG. 4, a synthetic capacitance between the lower electrodes 21 and 22 becomes a synthetic capacitance obtained by serially connecting a fixed, first capacitance of the lower electrode 21 and the driving electrode 31, a fixed, second capacitance of the lower electrode 22 and the driving electrode 32, a variable, third capacitance of the driving electrode 31 and the upper electrode 40, and a variable, fourth capacitance of the driving electrode 32 and the upper electrode 40, and is expressed by, for example, the above-explained equation (2).

In the capacitor bank shown in FIG. 4, an electrostatic attraction is produced by giving a potential difference between the upper electrode 40 and the driving electrodes 31 and 32. The upper electrode 40 is moved in a vertical direction (lateral direction) to the substrate surface (driving electrode) and the interval between the upper electrode 40 and the driving electrodes 31 and 32 is varied by the electrostatic attraction produced between the upper electrode 40 and the driving electrodes 31 and 32. The variable capacitance value (capacitance) CS of the MEMS element is varied by varying the distance between the electrodes forming the capacitive element. In accordance with this, the potential of the capacitive electrode (signal electrode 21) is displaced and a signal of radio frequency (RF) is output from the capacitive electrodes (signal/ground electrodes).

In the capacitor bank shown in FIG. 4, two fixed capacitances (CM) and two variable capacitances (CS) are serially connected between the signal electrode 21 and the ground electrode 22. The serially connected capacitance (synthetic capacitance) becomes the variable capacitance of the capacitor bank and is used as the variable capacitor for producing an output (RF voltage VRF).

(Operations)

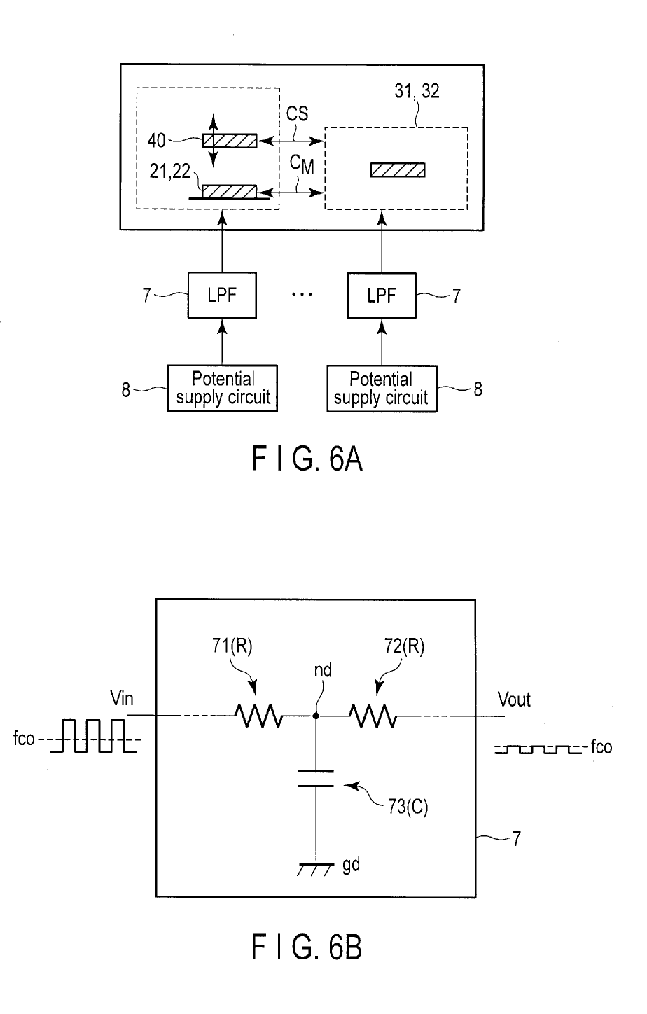

FIG. 6A illustrates an overall configuration for driving the capacitor bank shown in FIG. 4 and FIG. 5a, 5B. In the capacitor bank, the upper electrode 40 and the driving electrodes 31 and 32 are connected to potential supply circuits 8 via low-pass filters (LPFs) 7 as shown in FIG. 6A.

Each potential supply circuit 8 comprises, for example, a booster circuit. The potential supply circuit 8 boosts the voltage input from the outside by the booster circuit and outputs a supply potential Vin. The supply potential Vin is input to the low-pass filter 7. The supply potential Vin is a bias potential Vb or a ground potential Vgnd.

FIG. 6B is an equivalent circuit diagram showing an example of the low-pass filter 7. In the example shown in FIG. 6B, the low-pass filter 7 is composed of two resistance elements 71 and 72, and a fixed capacitive element 73. Two resistance elements 71 and 72 are serially connected. An end of a fixed capacitive element 73 is connected to a connection point nd of the two serially connected resistance elements 71 and 72. The other end of the fixed capacitive element 73 is connected to, for example, a ground terminal gd.

A signal (output potential) Vout passing through the low-pass filter 7 is supplied to the upper electrode 40 and the driving electrodes 31 and 32 as the bias potential Vb or the ground potential Vgnd of the capacitor bank. By disposing the low-pass filters 7 between the potential supply circuits 8 and the electrodes 40, 31 and 32, noise (high frequency component) produced by the potential supply circuits 8 can be prevented from propagating to RF output modules (electrodes 21, 22 and 40) of the capacitor bank.

The capacitor bank is driven by the potential supplied from the upper electrode 40 and the driving electrodes 31 and 32 as explained above.

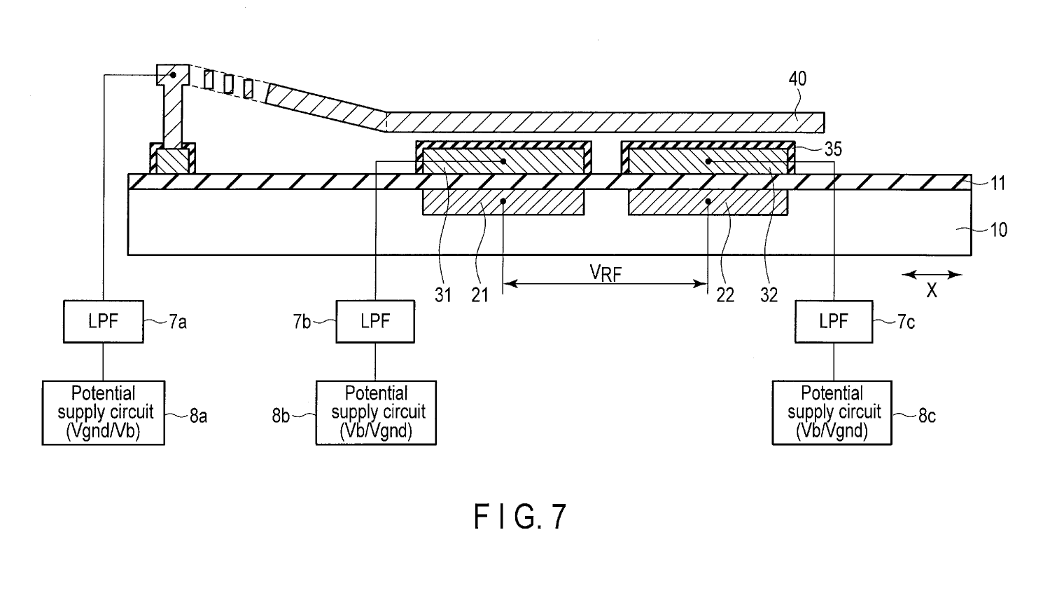

The operations of the capacitor bank will be explained more specifically with reference to FIG. 5A and FIG. 7. FIG. 7 shows the connection among the electrodes 40, 31 and 32, low-pass filters 7a, 7b and 7c, and potential supply circuits 8a, 8b and 8c, in the capacitor bank shown in FIG. 4. In addition, FIG. 5A and FIG. 7 show different states of the capacitor bank at the driving.

The upper electrode 40 is connected to the potential supply circuit 8a via the low-pass filter 7a as shown in FIG. 7. The first driving electrode 31 is connected to the potential supply circuit 8b via the low-pass filter 7b. The second driving electrode 32 is connected to the potential supply circuit 8c via the low-pass filter 7c. In the example shown in FIG. 7, the two driving electrodes 31 and 32 are connected to the potential supply circuits 8b and 8c, respectively.

When the capacitor bank is driven, a potential difference is made between the upper electrode 40 and the driving electrodes 31 and 32. For example, the capacitor bank is driven by supplying the ground potential Vgnd (for example, 0V) to the upper electrode 40 and supplying the bias potential Vb to the driving electrodes 31 and 32. When the upper electrode 40 is driven downwardly, the bias potential Vb is, for example, approximately 30V.

The electrostatic attraction is produced between the upper electrode 40 and the driving electrodes 31 and 32, due to the supplied potential difference. When the potential difference between the upper electrode 40 and the driving electrodes 31 and 32 is small or zero, the upper electrode 40 is in a state of floating upwardly as shown in FIG. 5A.

If the potential difference between the upper electrode 40 and the driving electrodes 31 and 32 is higher than or equal to a certain value, the movable upper electrode 40 starts moving and is attracted toward the driving electrodes 31 and 32, due to the electrostatic attraction produced between the upper electrode 40 and the driving electrodes 31 and 32. As a result, the upper electrode 40 is moved down toward the driving electrodes 31 and 32. The potential difference at which the upper electrode 40 starts moving is called a pull-in voltage.

A state in which the potential difference between the upper electrode 40 and the driving electrodes 31 and 32 becomes greater than or equal to a certain value (pull-in voltage) and the upper electrode 40 is moved down toward the driving electrodes 31 and 32 as shown in, for example, FIG. 7 is called a down-state. In contrast, a state in which the potential difference between the upper electrode 40 and the driving electrodes 31 and 32 becomes smaller than the pull-in voltage and the upper electrode 40 is moved upwardly as shown in, for example, FIG. 5A is called an up-state.

In addition, when the upper electrode 40 is returned from the down-state to the up-state, a potential difference (hereinafter called a pull-out voltage) greater than or equal to a certain value is supplied between the upper electrode 40 and the driving electrodes 31 and 32.

(Manufacturing Method)

A method of manufacturing the capacitor bank shown in FIG. 4 will be explained.

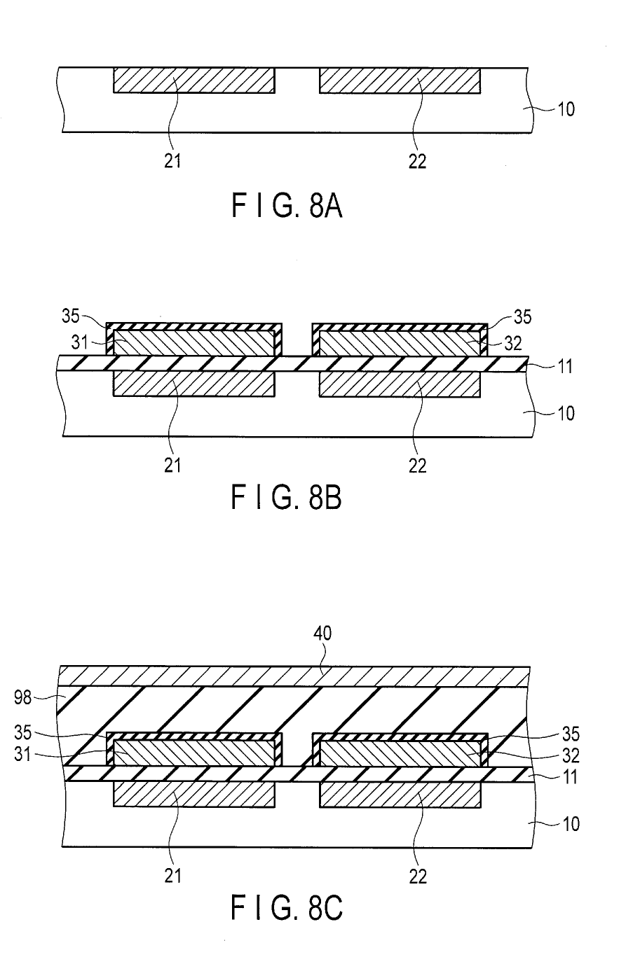

First, trenches are formed in the substrate 10 by, for example, photolithography and reactive ion etching (RIE) as shown in FIG. 8A. After that, a conductor is deposited on the substrate 10 and the trenches by, for example, chemical vapor deposition (CVD) or sputtering. The conductor is subjected to planarization using the upper surface of the substrate 10 as a stopper by chemical mechanical polishing (CMP). The lower electrodes 21 and 22 are thereby buried in the trenches by self-alignment.

Next, the insulating film 11 is deposited on the surface of the substrate 10 and the lower electrodes 21 and 22 by, for example, CVD and thermal oxidation as shown in FIG. 8B. Then, the conductor is deposited on the insulating film 11 by, for example, CVD and sputtering. After that, the conductor is processed in a predetermined shape by photolithography and RIE. The driving electrodes 31 and 32 are thereby formed on positions which vertically overlap the lower electrodes 21 and 22, respectively. Furthermore, the protective insulating film 35 is formed on the driving electrodes 31 and 32 by, for example, CVD, thermal oxidation, etc.

As a result, two MIM elements are formed by the protective insulating film 35 sandwiched between the lower electrodes 21 and 22 and the driving electrodes 31 and 32. It should be noted that an interconnect, a dummy layer, etc., of the MEMS device may be formed of the same material as the driving electrodes 31 and 32 on the insulating film 11, simultaneously with the formation of the driving electrodes 31 and 32.

Next, a sacrificial layer 98 is formed on the insulating films 11 and 35 by, for example, CVD, a coating method, etc., as shown in FIG. 8C. The sacrificial layer 98 needs only to ensure a predetermined etching selective ratio to the material formed in a lower layer and a material to be explained later which is formed on an upper level than the sacrificial layer.

Then, a conductor which is to be the upper electrode 40 is deposited on the sacrificial layer 98 by, for example, CVD and sputtering. A conductor on the sacrificial layer 98 is processed in a predetermined shape by, for example, photolithography and RIE. The upper electrode 40 is thereby formed.

After that, the sacrificial layer 98 is selectively etched by, for example, wet etching. A cavity is thereby formed between the upper electrode 40 and the driving electrodes 31 and 32 as shown in FIG. 5A, 5B.

The anchor portions 51 and 52 are formed by forming opening portions on the sacrificial layer 98 before formation of the conductor of the upper electrode 40 and by burying the conductor in the opening portions. Furthermore, the spring portion 41 is formed by patterning the conductor. In addition, the spring portions 53 may be formed in an insulating film pattern on the sacrificial layer 98 so as to make connection between the upper electrode 40 and the anchor portions 52, after formation of the upper electrode 40 and the spring portion 41.

The capacitor bank in the layered electrode structure is completed in the above-explained process as shown in FIG. 4 and FIG. 5.

### Second Embodiment

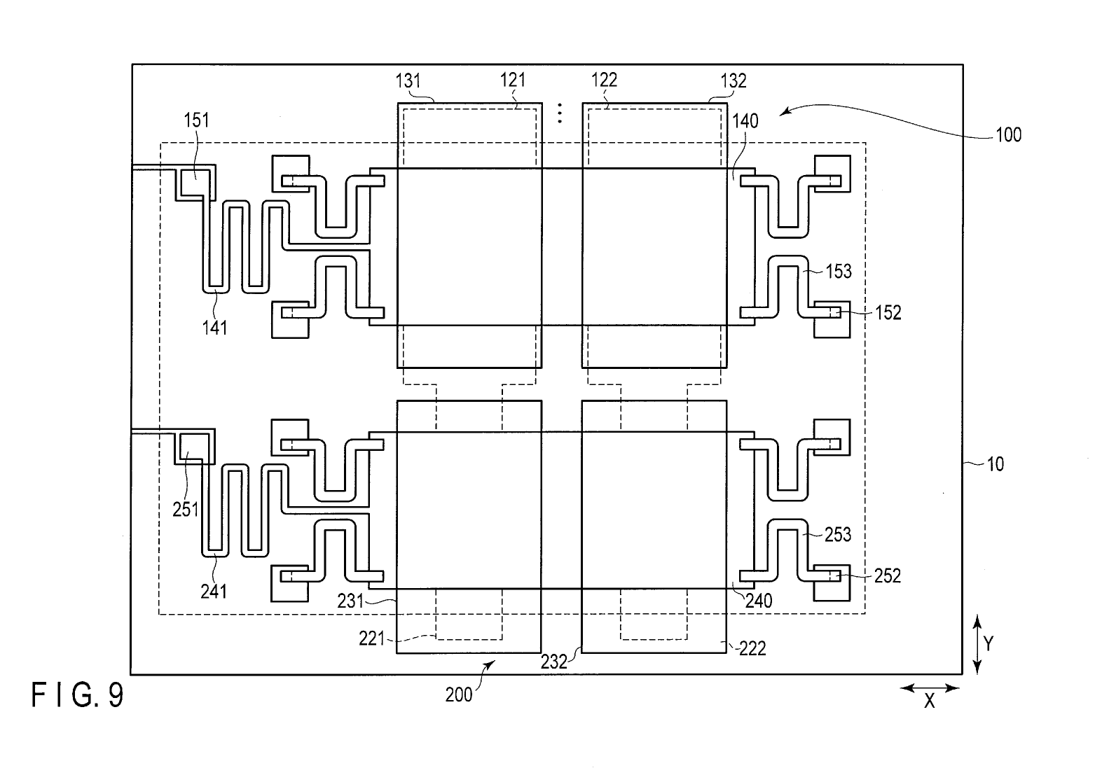

FIG. 9 is a plan view showing a schematic configuration of a variable capacitance bank device of a second embodiment. Like or similar portions to the portions shown in FIG. 4 are denoted by the same reference numbers and symbols, and their detailed explanations are hereinafter omitted.

In the present embodiment, a variable capacitance bank device is composed of two capacitor banks shown in FIG. 4.

A first capacitor bank 100 and a second capacitor bank 200 are disposed adjacently with each other on a substrate 10.

The first capacitor bank 100 is composed of a first lower electrode 121, a second lower electrode 122, a first driving electrode 131, a second driving electrode 132, an upper electrode 140, etc., similarly to the capacitor bank shown in FIG. 4. Similarly, the second capacitor bank 200 is composed of a first lower electrode 221, a second lower electrode 222, a first driving electrode 231, a second driving electrode 232, an upper electrode 240, etc.

The lower electrodes 121 and 221 are sequentially provided between the first capacitor bank 100 and the second capacitor bank 200, and the width of the lower electrode 221 is smaller than the width of the lower electrode 121. Similarly, the lower electrodes 122 and 222 are sequentially provided between the first capacitor bank 100 and the second capacitor bank 200, and the width of the lower electrode 222 is smaller than the width of the lower electrode 122. In other words, the areas of the lower electrodes 221 and 222 are smaller than the areas of the lower electrodes 121 and 122, respectively. More specifically, the areas of the lower electrodes 221 and 222 (more strictly, the overlap areas on the driving electrodes 231 and 232) are one-third the areas of the lower electrodes 121 and 122 (more strictly, the overlap areas on the driving electrodes 131 and 132), respectively.

In addition, the upper electrode 140 is connected to an anchor portion 150 via a spring portion 141 while the upper electrode 240 is connected to an anchor portion 251 via a spring portion 241, similarly to the configuration shown in FIG. 4. Furthermore, the upper electrode 140 is connected to an anchor portion 152 via a spring portion 151 while the upper electrode 240 is connected to an anchor portion 252 via a spring portion 253, similarly to the configuration shown in FIG. 4.

In such a configuration, MIM elements (MIM1) 101 and 103 can be formed of the lower electrodes 121 and 122 and the driving electrodes 131 and 132 of the first capacitor bank 100, and MEMS elements (MEMS1) 103 and 104 can be formed of the driving electrodes 131 and 132 and the upper electrode 140 of the first capacitor bank 100, similarly to the first embodiment. Furthermore, MIM elements (MIM2) 201 and 202 can be formed of the lower electrodes 221 and 222 and the driving electrodes 231 and 232 of the second capacitor bank 200, and MEMS elements (MEMS2) 203 and 204 can be formed of the driving electrodes 231 and 232 and the upper electrode 240 of the second capacitor bank 200.

Since the widths of the lower electrodes 221 and 222 are one-third the widths of the lower electrodes 121 and 122, respectively, the capacitances of the MIM elements 201 and 202 can be set to be one-third the capacitances of the MIM elements 101 and 102, respectively.

Therefore, four capacitance values can be obtained by power-on/power-off of the MEMS 1 and 2 and the 2-bit variable capacitance bank can be implemented, similarly to the first embodiment. Furthermore, since the MEMS structure is unified and the MIM structures (areas of the lower electrodes) need only to be modified in the first capacitor bank 100 and the second capacitor bank 200, the same advantages as those of the first embodiment can be obtained.

### Third Embodiment

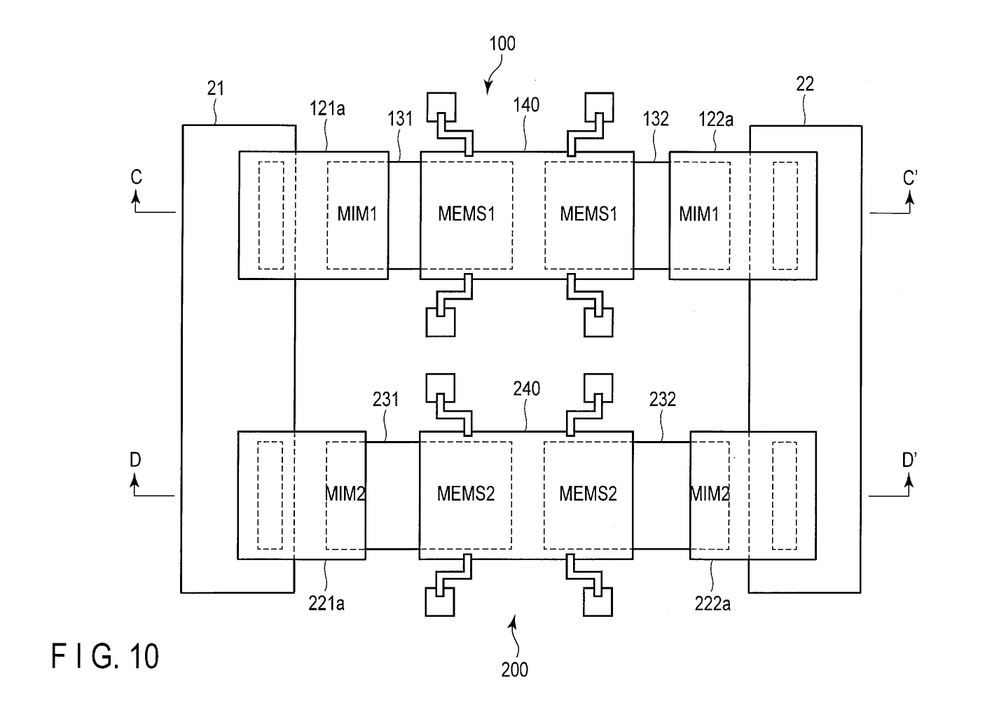

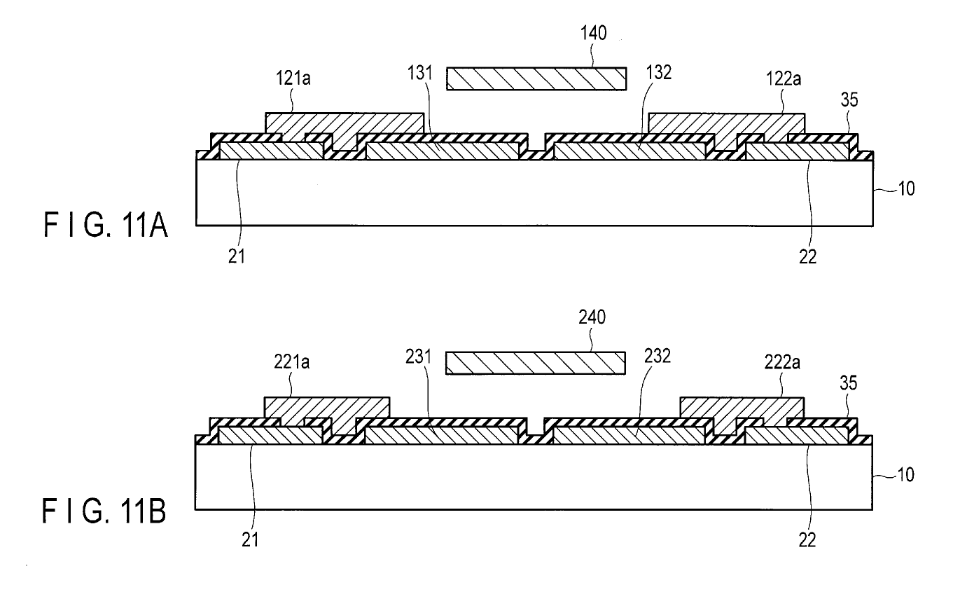

FIG. 10 is a plan view showing a basic configuration of a variable capacitance bank device of a third embodiment. FIG. 11A is a cross-sectional view seen along an arrow direction of a line C-C′ in FIG. 10, and FIG. 11B is a cross-sectional view seen along an arrow direction of a line D-D′ in FIG. 10.

Two capacitor banks 100 and 200 commonly comprising lower electrodes 21 and 22 are disposed on a substrate 10. The lower electrodes 21 and 22 are extended in a Y direction and disposed parallel to each other. An insulating substrate or a semiconductor substrate of silicon, etc., having an insulating film disposed thereon may be used as the substrate 10.

Driving electrodes 131 and 132 which constitute the first capacitor bank 100 is formed between the lower electrodes 21 and 22, on the substrate 10. Surfaces of the lower electrodes 21 and 22 and the driving electrodes 131 and 132 are covered with a protective insulating film 35.

A first auxiliary electrode 121a connected in part to the first lower electrode 21 is formed on the protective insulating film 35, and the auxiliary electrode 121a overlaps in part the first driving electrode 131. A second auxiliary electrode 122a connected in part to the second lower electrode 22 is formed on the protective insulating film 35, and the auxiliary electrode 122a overlaps in part the second driving electrode 132. In other words, if the auxiliary electrodes 121a and 122a are regarded as parts of the lower electrodes 21 and 22, the parts of the lower electrodes 21 and 22 overlap the driving electrodes 131 and 132 in part. The overlapping portion of the auxiliary electrode 121a and the driving electrode 131, and the overlapping portion of the auxiliary electrode 122a and the driving electrode 132 form MIM elements, respectively.

An upper electrode 140 is disposed above the driving electrodes 131 and 132 so as to be opposed to other parts of the driving electrodes 131 and 132. The upper electrode 140 can be moved in a vertical direction by spring portions and anchor portions, similarly to the example shown in FIG. 4. The first capacitor bank 100 is thereby constituted.

The second capacitor bank 200 is substantially the same in configuration as the first capacitor bank 100, but the areas of overlapping portions between auxiliary electrodes 221a and 222a and driving electrodes 231 and 232 are different from the areas of the overlapping portions between the auxiliary electrodes 121a and 122a and the driving electrodes 131 and 132. More specifically, the areas of the overlapping portions between the auxiliary electrodes 221a and 222a and the driving electrodes 231 and 232 are one-third the areas of the overlapping portions between the auxiliary electrodes 121a and 122a and the driving electrodes 131 and 132.

In other words, the lower electrodes 21 and 22, the auxiliary electrodes 121a and 122a, and the driving electrodes 131 and 132 constitute a MIM1 while the lower electrodes 21 and 22, the auxiliary electrodes 221a and 222a, and the driving electrodes 231 and 232 constitute a MIM2 having a smaller capacitance than the MIM1.

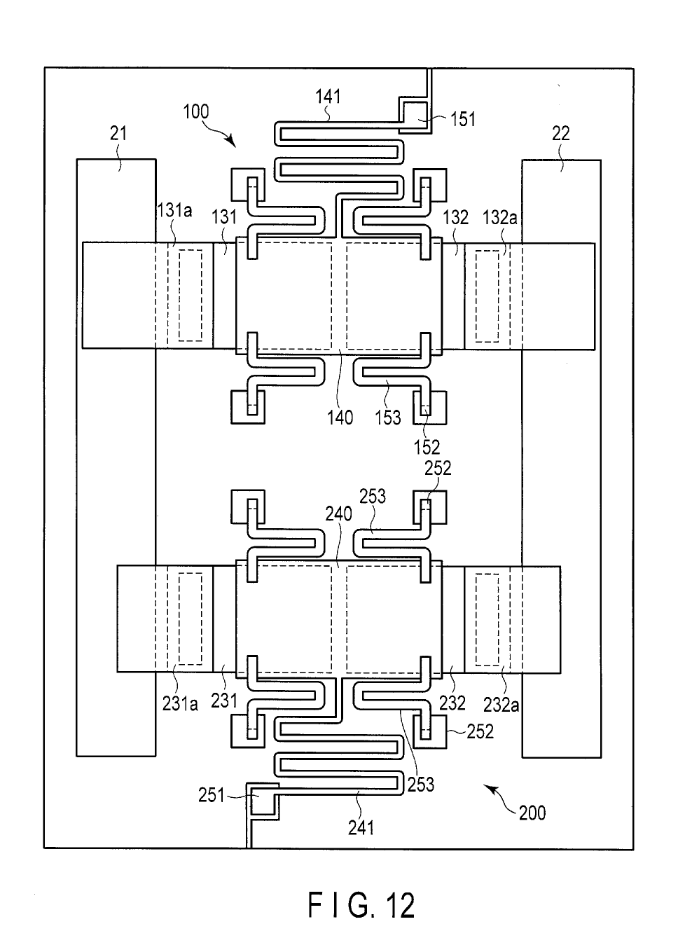

FIG. 12 is a plan view showing a schematic configuration of the variable capacitance bank device of the present embodiment more specifically.

Besides the configuration shown in FIG. 10, the upper electrode 140 of the first capacitor bank 100 is connected to an anchor portion 151 via a spring portion 141, and an upper electrode 240 of the second capacitor bank 200 is connected to an anchor portion 251 via a spring portion 241. In addition, the upper electrode 140 of the first capacitor bank 100 is supported by a spring portion 153 and an anchor portion 152 so as to be movable in a vertical direction. Furthermore, the upper electrode 240 of the second capacitor bank 200 is supported by a spring portion 253 and an anchor portion 252 so as to be movable in a vertical direction.

Thus, in the present embodiment, too, MIM elements (MIM1) 101 and 102 can be formed of the lower electrodes 221 and 222 and the driving electrodes 231 and 232 of the first capacitor bank 100, and MEMS elements (MEMS2) 103 and 104 can be formed of the driving electrodes 131 and 132 and the upper electrode 140 of the first capacitor bank 100. Furthermore, MIM elements (MIM2) 201 and 202 can be formed of the lower electrodes 21 and 22 and the driving electrodes 231 and 232 of the second capacitor bank 200, and MEMS elements (MEMS2) 203 and 204 can be formed of the driving electrodes 231 and 232 and the upper electrode 240 of the second capacitor bank 200.

It should be noted that auxiliary electrodes 131a, 132a, 231a and 232a are used instead of the auxiliary electrodes 121a, 122a, 221a, and 222a, in the example of FIG. 12. The auxiliary electrodes 131a and 132a are formed on a protective insulating film 35, and connected in part to the driving electrodes 131 and 132, and overlap in part the lower electrodes 21 and 22 on the protective insulating film 35. In other words, if the auxiliary electrodes 131a and 132a are regarded as parts of the driving electrodes 131 and 132, the parts of the driving electrodes 131 and 132 overlap the lower electrodes 21 and 22 in part.

Similarly, the auxiliary electrodes 231a and 232a are connected in part to the driving electrodes 231 and 232, and overlap in part the lower electrodes 21 and 22 on the protective insulating film 35. In other words, if the auxiliary electrodes 231a and 232a are regarded as parts of the driving electrodes 231 and 232, the parts of the driving electrodes 231 and 232 overlap the lower electrodes 21 and 22 in part. The areas of the overlapping portions between the auxiliary electrodes 231a and 232a and the lower electrodes 21 and 22 are one-third the areas of the overlapping portions between the auxiliary electrodes 131a and 132a and the lower electrodes 21 and 22.

In this case, too, the lower electrodes 21 and 22, and the driving electrodes 131 and 132 (and the auxiliary electrodes 131a and 132a) can constitute a MIM1 while the lower electrodes 21 and 22, and the driving electrodes 231 and 232 (and the auxiliary electrodes 231a and 232a) can constitute a MIM2 having a smaller capacitance than the MIM1, similarly to the case shown in FIG. 10 and FIG. 11.

In other words, the auxiliary electrodes can be connected to any of the lower electrodes and the driving electrodes for formation of the MIM elements. More specifically, the lower electrodes in part may overlap the driving electrodes in part or the driving electrode in part may overlap the lower electrodes in part.

In such a configuration, four capacitance values can be obtained by power-on/power-off of the MEMS 1 and 2 and the 2-bit variable capacitance bank can be implemented, similarly to the second embodiment. Advantages similar to the advantages of the first embodiment can be therefore obtained.

In addition, the present embodiment also obtains a benefit that the manufacturing process can be simplified since the lower electrode 21 and 22 are not buried in the substrate 10, but can be formed on the substrate 10 simultaneously with the driving electrode 131, 132, 231, and 232.

### Modified Embodiment

The embodiments are not limited to those described above.

Two capacitor banks are connected parallel in the embodiments, but a variable capacitance bank device of more bits can be implemented by connecting at least three capacitor banks in parallel. For example, if three capacitor banks are used, a third capacitor bank is disposed besides the first and second capacitor banks of the embodiments and the capacitance at the power-on of the MEMS element of the third capacitor bank may be set at C/16. Thus, the capacitance of the MIM element (MIM3) of the third capacitor bank may be set to be one-seventh the capacitance of the MIM1. For this purpose, the areas of the lower electrodes (overlapping portions of the lower electrodes and the driving electrodes) of the third capacitor bank may be set to be one-seventh the areas of the lower electrodes (overlapping portions of the lower electrodes and the driving electrodes) of the first capacitor bank.

In addition, the capacitance of the first MEMS element and the capacitance of the second MEMS element do not need to be completely the same as each other in each capacitor bank, and a small difference in the capacitances is a permissible range. Furthermore, the capacitances of the first and second MEMS elements do not need to be completely the same as each other in different capacitor banks, and a small difference in the capacitances is a permissible range. Similarly, the capacitance of the first MIM element and the capacitance of the second MIM element do not need to be completely the same as each other in each capacitor bank, and a small difference in the capacitances is a permissible range. A small variation may occur in the same design due to lithographic displacement, etc., in the manufacturing process, which is naturally included in the inventive scope.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A variable capacitance bank device, comprising:
a plurality of capacitor banks for generation of a variable capacitance, the plurality of capacitor banks being connected parallel,
each of the capacitor banks comprising:
a first lower electrode and a second lower electrode disposed on a substrate;
a first driving electrode having a fixed first capacitance generated between the first driving electrode and the first lower electrode;
a second driving electrode having a fixed second capacitance generated between the second driving electrode and the second lower electrode; and
a common upper electrode disposed to be movable in a direction of facing the first and second lower electrodes, having a variable third capacitance generated between the common upper electrode and the first driving electrode, and having a variable fourth capacitance generated between the common upper electrode and the second driving electrode,
a capacitance value between the first lower electrode and the second lower electrode being determined based on a value of a synthetic capacitance obtained by serially connecting the first, second, third and fourth capacitances, the value of the synthetic capacitance being used as the variable capacitance,
the first and second capacitances being set at an equal capacitance value C_{M} in a same capacitor bank, and set at different capacitance values in different capacitor banks,
the third and fourth capacitances being set at a same capacitance value C_{S} in the same capacitor bank, and set at the same capacitance value C_{S} in the different capacitor banks.

2. The device of claim 1, wherein
an area of the upper electrode is set at an equal value in different capacitor banks.

3. The device of claim 2, wherein
overlap areas of the upper electrode on the respective first and second driving electrodes in the same capacitor bank are set at an equal value S_{S}, and overlap areas of the upper electrodes on the respective first and second driving electrodes in different capacitor banks are set at the equal value S_{S}, and
an overlap area of the first driving electrode on the first lower electrode and an overlap area of the second driving electrode on the second lower electrode are set at an equal value S_{M} in a same capacitor bank, and set at different values in different capacitor banks.

4. The device of claim 3, wherein
the first and second driving electrodes are disposed on the substrate, parts of the first and second lower electrodes are disposed on parts of the first and second driving electrodes through an insulating film, and the upper electrode is disposed on other parts of the first and second driving electrodes.

5. The device of claim 3, wherein
the first and second driving electrodes are disposed on the substrate, parts of the first and second driving electrodes are disposed on parts of the first and second lower electrodes through an insulating film, and the upper electrode is disposed on other parts of the first and second driving electrodes.

6. The device of claim 3, wherein
the first and second driving electrodes are disposed on the first and second lower electrodes through an insulating film, and the upper electrode is disposed above the first and second driving electrodes.

7. The device of claim 1, wherein
the upper electrode is supported above the first and second driving electrodes by an anchor portion disposed on the substrate.

8. The device of claim 7, wherein
the upper electrode is moved based on a potential difference between the upper electrode and the first and second driving electrodes.

9. A variable capacitance bank device, comprising:
a first capacitor bank and a second capacitor bank for generation of a variable capacitance, the first and second capacitor banks being connected parallel,
each of the first and second capacitor banks comprising:
a first lower electrode and a second lower electrode disposed on a substrate to have a same area;
a first driving electrode having a fixed first capacitance generated between the first driving electrode and the first lower electrode;
a second driving electrode having a fixed second capacitance generated between the second driving electrode and the second lower electrode, and generated to have a same area as the first driving electrode; and
a common upper electrode disposed to be movable in a direction of facing the first and second driving electrodes, having a variable third capacitance generated between the common upper electrode and the first driving electrode, and having a variable fourth capacitance generated between the common upper electrode and the second driving electrode,
a capacitance value in the first and second lower electrodes being determined based on a value of a synthetic capacitance obtained by serially connecting the first, second, third and fourth capacitances, the value of the synthetic capacitance being used as the variable capacitance,
the first and second capacitances being set at an equal capacitance value C_{M} in a same capacitor bank, and set at different capacitance values in the first and second capacitor banks,
the third and fourth capacitances being set at an equal capacitance value C_{S} in the same capacitor bank, and set at the equal capacitance value C_{S} in the first and second capacitor banks.

10. The device of claim 9, wherein
the capacitance value C_{M2} of the second capacitor bank is one-third the capacitance value C_{M1} of the first capacitor bank.

11. The device of claim 9, wherein
an area of the upper electrode is set to be equal in the first and second capacitor banks.

12. The device of claim 11, wherein
the first and second driving electrodes are disposed on the substrate, parts of the first and second lower electrodes are disposed on parts of the first and second driving electrodes through an insulating film, and the upper electrode is disposed on other parts of the first and second driving electrodes, and
an overlap area of each of the driving electrodes on each of the lower electrodes in the second capacitor bank is a third of an overlap area of each of the driving electrodes on each of the lower electrodes in the first capacitor bank.

13. The device of claim 11, wherein
the first and second driving electrodes are disposed on the substrate, parts of the first and second driving electrodes are disposed on parts of the first and second lower electrodes through an insulating film, and the upper electrode is disposed on other parts of the first and second driving electrodes, and
an overlap area of each of the driving electrodes on each of the lower electrodes in the second capacitor bank is a third of an overlap area of each of the driving electrodes on each of the lower electrodes in the first capacitor bank.

14. The device of claim 11, wherein
the first and second driving electrodes are disposed on the first and second lower electrodes through an insulating film, and the upper electrode is disposed above the first and second driving electrodes, and
an area of each of the lower electrodes in the second capacitor bank is a third of an area of each of the lower electrodes in the first capacitor bank.

15. The device of claim 9, wherein
the upper electrode is supported above the first and second driving electrodes by an anchor portion disposed on the substrate.

16. The device of claim 15, wherein
the upper electrode is moved based on a potential difference between the upper electrode and the first and second driving electrodes.

17. A variable capacitance bank device, comprising:
a plurality of capacitor banks for generation of a variable capacitance, the plurality of capacitor banks being connected parallel with each other,
each of the capacitor banks being constituted by serially connecting a fixed capacitor for generation of a fixed capacitance and a MEMS capacitor for generation of the variable capacitance,
capacitances of the fixed capacitors in different capacitor banks being set at different values,
capacitances of the MEMS capacitors in different capacitor banks being set at an equal value.
